(19) United States
(12) Patent Application Publication
(10) Pub. No.: US 2002/0067730 A1
(43) Pub. Date: Jun. 6, 2002

(54) Method and apparatus for IP multicast content distribution system having national and regional demographically targeted advertisement insertion

(75) Inventors: Larry W. Hinderks, Reno, NV (US); Ryland Reed, Dallas, TX (US); Gregory Preston, Colleyville, TX (US); Timothy Hegwood, McKinney, TX (US)

Correspondence Address: NIXON & VANDERHYE P.C., 8th Floor, 1100 North Glebe Road, Arlington, VA, 22201, US

(73) Assignee: STARGUIDE DIGITAL NETWORKS, INC.

(21) Appl. No.: 10/002,629

(22) Filed: Dec. 5, 2001

Related U.S. Application Data
(60) Provisional application No. 60/251,746, filed on Dec. 5, 2000.

(51) Int. Cl. H04L 12/56

(52) U.S. Cl. 370/395.52; 370/432; 370/529

(57) ABSTRACT

A method and system is provided for inserting national, regional, and/or demographically targeted information content, such as commercial advertisements, into streaming IP multicast program content delivery streams, such as streaming audio, video or other multimedia content, provided to Internet users via a wide area multicast distribution network. One or more IP datagram/packet replication devices accept packets of streaming digital data content from a multicast content distribution network or other streaming digital content generation source to produce a plurality of multicast content streams. Content streams are provided to an advertisement insertion (AI) device that is capable of implementing per-stream insertion of predetermined advertisement content. Multicast content streams containing the inserted advertisement content are distributed to multicast recipients by one or more regional IP service provider networks. Specific demographic targeting of inserted advertisement content is accomplished on a per-stream basis at the regional network level by modifying IP header and UDP header information per data packet during the packet replication process.

### CROSS REFERENCE TO RELATED APPLICATIONS

The present application claims priority from related provisional application Ser. No. 60/251,746, filed Dec. 5, 2000, entitled “Method and Apparatus for Demographically Targeted Regional Advertisement Insertion”, the content of which is hereby incorporated by reference into this specification.

### FIELD OF THE INVENTION

The present invention relates to the multicasting of digital information content, and more particularly, to the insertion and demographic targeting of advertisements into IP multicast content distributed over national and regional networks.

### BACKGROUND AND SUMMARY OF THE INVENTION

Advertisement insertion in the broadcast industry is an important form of revenue generation. Often advertisements are created to target specific demographically defined groups of consumers (e.g., males of ages 18-34, married persons over 40, etc.). Moreover, the ability of a broadcaster or advertiser to deliver specific advertisements to a targeted demographic in a selected area can greatly increase the value of a particular advertisement. Since the economic value of broadcast advertisement time and content is typically marketed to sponsors based on the particular demographics of an anticipated audience to a broadcast program, the ability, for example, to deliver demographically tailored advertisements to an audience or an individual of known demographic profile is highly desirable.

Within the domain of conventional “analog” broadcast radio and television, the process of advertisement insertion into a particular broadcast may be as simple as switching from an original program/content source to an alternate content source producing the advertisement and, when the advertisement is over, switching back to the original program source. Conventionally, broadcast advertisement content insertion may occur both at “national” network and local/regional network levels. At the national network level, advertisements are often inserted into the network feed before the broadcast content is transmitted over, for example, a particular national distribution network. At the regional network level, local advertisements may be inserted into a received national feed by, for example, the regional local radio or TV broadcast station and such advertisements may typically replace some or all of the “national” network advertisements. Such local advertisements are generally targeted to the demographics of the service area of the particular broadcast station and may, for example, advertise the local tire store or restaurant.

Unfortunately, broadcast companies that utilize conventional/distribution media such as radio, TV, cable and satellite, typically do not have the capability to selectively deliver different advertisements to individual demographic groups consisting of one or more viewers/listeners. No conventional broadcast methods are currently known that provide broadcasters with the ability to simultaneously deliver different advertisements to different individuals/recipients having different demographic profiles within the same geographic region. For example, it would be practically impossible for a conventional radio or TV broadcaster to provide substantially different advertisements to 25-to-34 year old male listeners/viewers and at the same time to 34-to-55 year old female listeners/viewers that happen to be receiving the same broadcast content program in the same local geographic region. Aside from the normal inherent technical difficulties of such an endeavor, a further problem of conventional broadcasters is the general inability to determine or distinguish who and/or which demographic of individuals may be receiving a particular program broadcast.

In this regard, the inventors of the present invention have recognized that delivery of information/program content via the Internet can provide the desired ability to discern the demographic profile of individual content recipients due to the inherent two-way communications link that exists between the client and server computers. Moreover, for multicast recipients utilizing Internet connectivity to a content provider, relatively inexpensive and readily available conventional mechanisms (e.g., a browser application within a recipient's computer/reception equipment) may be employed to provide feedback to the multicasting source conveying—conveying at least a certain limited amount of information as to the identity and/or demographic profile of individual recipients. Moreover, the inventors of the present invention have recognized that delivering streaming content to a large number of simultaneous recipients is best accomplished using an approach based on a “multicast” distribution model. One such multicast media distribution system is described in commonly assigned U.S. Pat. No. 6,101,180 to Donahue et al, the content of which is incorporated by reference into this specification.

In accordance with the conventional multicast model, a content source provider/producer transmits original content to a multicast delivery network that makes multiple copies of the multicast content during the course of delivery to a plurality of regional network or Internet destinations. Typically, special Internet transmission equipment, such as a router that is multicast “aware” (enabled), must be used to perform packet replication and packet forwarding to the various multicast recipient destinations.

Within the contemporary information delivery infrastructure of the Internet, there effectively exists a “national” transmission facility commonly referred to as the Internet “backbone”. It is this backbone that is primarily responsible for delivery of IP data content across large geographical regions (e.g., nationally). Smaller geographical regions/locales are typically served by regional data delivery infrastructures called “regional networks” also called “last mile” networks. These regional networks typically interface to the Internet backbone at what is known as a “point of presence” (POP) and effectively connect the computers of individual users/recipients to the Internet backbone. Such regional networks are somewhat analogous to, for example, a local TV station in the sense that they may receive “national” broadcast/multicast content and deliver it to individual recipients within a specific limited geographic service region.

The present invention provides a novel solution to the above-mentioned problems inherent to both the distribution of conventional broadcast advertisements and the distribution of advertisements via unicast models over the Internet. More specifically, the present invention provides a novel and efficient method and arrangement for insertion of both national and regional advertising into distributed IP multicast content streams. In addition, the present invention provides a novel method and apparatus that allows for the insertion of custom advertisements and other content into high bandwidth multicast content streams that may then be delivered to specific demographically targeted recipients connected to the Internet. In this manner, the present invention empowers high bandwidth content providers (at both the national/international and regional distribution levels) with an ability to tailor both content and advertising to the interests of a targeted demographic of recipients.

In accordance with an example embodiment of the present invention, one or more IP data packet replicators accept packets of digital information/multimedia content from a multicast content distribution network or content source to produce a plurality of digital multicast content streams. One or more content streams are provided to an advertisement insertion (AI) device array that enables per-stream advertisement content insertion. The AI devices are responsive to stream embedded advertisement “trigger” codes or manually input commands which initiate insertion of locally stored advertisements or other content into the IP multicast content stream. Multicast content streams containing inserted advertisements may then be distributed by one or more regional IP networks. Specific demographic targeting of inserted advertisement content is accomplished on a per-stream basis by modifying IP header and UDP header information per data packet during the packet replication process. In this manner, a novel method and system is provided for inserting national, regional, and/or demographically targeted information content, such as commercial advertisements, into high bandwidth multicast data delivery streams that provide streaming audio, video, digital data or other multimedia content to subscribing Internet users.

### BRIEF DESCRIPTION OF THE DRAWINGS

These and other features and advantages provided by the invention would be better and more completely understood by referring to the following detailed description of presently preferred embodiments in conjunction with the drawings of which:

FIG. 1 is a high-level schematic diagram of a multicast content generation and advertisement insertion system arrangement in accordance with the present invention;

FIG. 2 is a schematic diagram of example multicast content generation system hardware for implementing per-stream national advertisement insertion in accordance with the present invention;

FIG. 3 is a schematic block diagram of an example advertisement insertion/packet replication unit in accordance with the present invention;

FIG. 4 is a diagram illustrating multicast stream content insertion;

FIG. 5 is a schematic block diagram illustrating an example regional advertisement insertion system arrangement in accordance with the present invention;

FIG. 6 is a block diagram illustrating an example IP multicast demographic advertisement insertion/generating system arrangement in accordance with the present invention;

FIG. 7 is a diagram illustrating a packet replication example having Group Address modification; and

FIG. 8 is a block diagram illustrating an example demographic address mapping per multicast data stream.

### DETAILED DESCRIPTION OF EXAMPLE EMBODIMENTS OF THE INVENTION

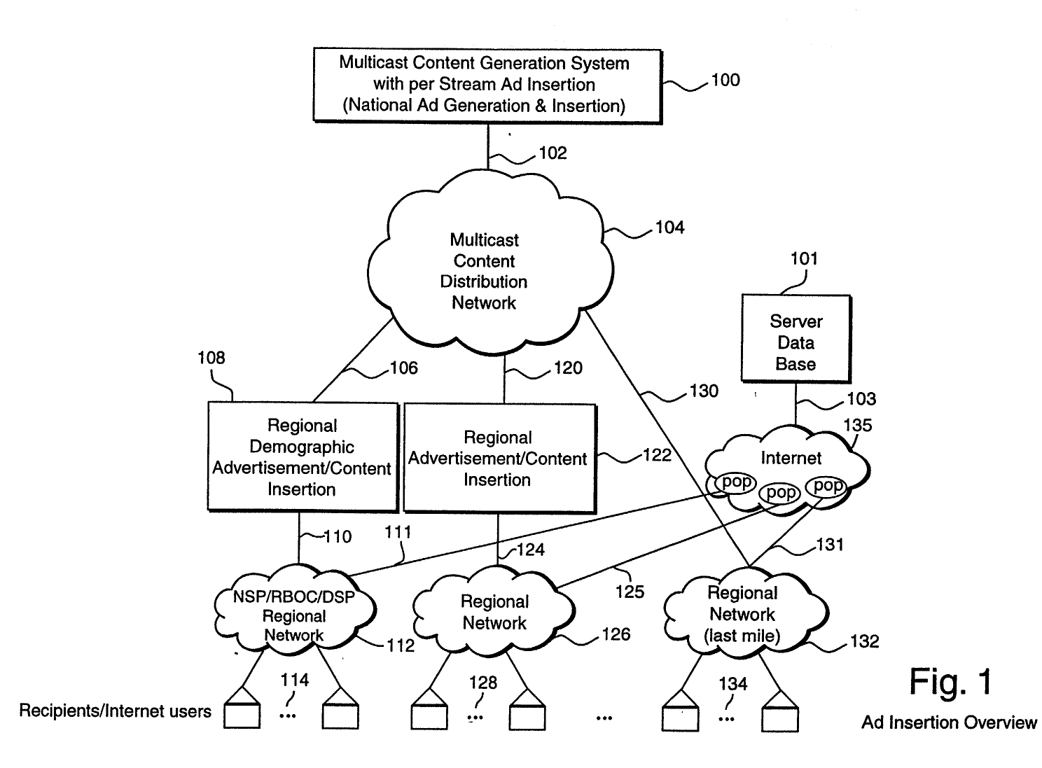

FIG. 1 illustrates a high level architecture arrangement for an example multicast content generation and advertisement insertion system of the present invention. In this example, a Multicast Content Generation System 100 is connected to a Multicast Content Distribution Network (104) for distribution of generated multicast programs/content to geographically disbursed subscriber locations. Multicast content distribution network 104 provides one or more regional IP networks (112, 126, 132) with multicast streaming content for distribution to subscribing recipients (114, 128, 134). Although the following description of an example embodiment of the present invention is based on IP multicasting utilizing IP version 4 (IPv4), one of ordinary skill in the art would recognize that other digital transport capable forms of multicast such as IPv6 or, for example, ATM multicast may also be utilized in an implementation of the present invention.

In the above context, multicast content recipients (Internet users) 114, 128, 134 may subscribe to or “join” a specific IP Group Address to gain access particular multicast program content. At least one program content generation system (100) is responsible for producing and encoding multimedia or other program content (e.g., streaming audio/video) and scheduling that content to be distributed via the specific IP Group Addresses at predetermined scheduled times.

Multicast Content distribution network 104 may, for example, be any digital communications network infrastructure (preferably a WAN) that supports Multicast transport capabilities. In a preferred example embodiment, multicast distribution network 104 comprises a digital communications satellite network capable of providing a high bandwidth digital content stream directly to one or more point of presence (POP) of a service provider (e.g., ISP, NSP, RBOC, DSP). In this manner, high bandwidth content may be multicast directly to many geographically diverse service provider points of presence (not necessarily on the Internet) while bypassing the Internet backbone and any associated communication bottlenecks. Alternate multicast capable communication network infrastructures, such as frame relay or ATM backbone WAN infrastructures, that effectively bypass the Internet backbone may also be used.

One or more geographically limited networks, shown as regional networks 112, 126 and 132, which are coupled/connected (106, 120, 130) to Multicast distribution network 104, deliver multicast content to subscribers/recipients 114, 128 and 132 within the geographic limits of respective regional networks 112, 126 . . . 134. Such regional networks may be provided by one or more Internet Service Provider (ISP) and/or Network Service Providers (NSP). Regional networks 112, 126 and 132 may also be connected (111, 125 and 131) to the Internet 135. Typically, Regional Bell Operating Companies (RBOC) function as a Network Service Providers (NSP) responsible for such “last mile” infrastructure, while an Internet Service Provider (ISP) may be primarily responsible for connectivity solely to the Internet. In this manner, Multicast content recipients (114, 128 and 134) may interact within their respective network environments via any conventional Internet capable communication device such as, for example, an Internet capable personal or portable computer running a conventional Internet browser application (such as, for example, Microsoft® Windows Explorer).

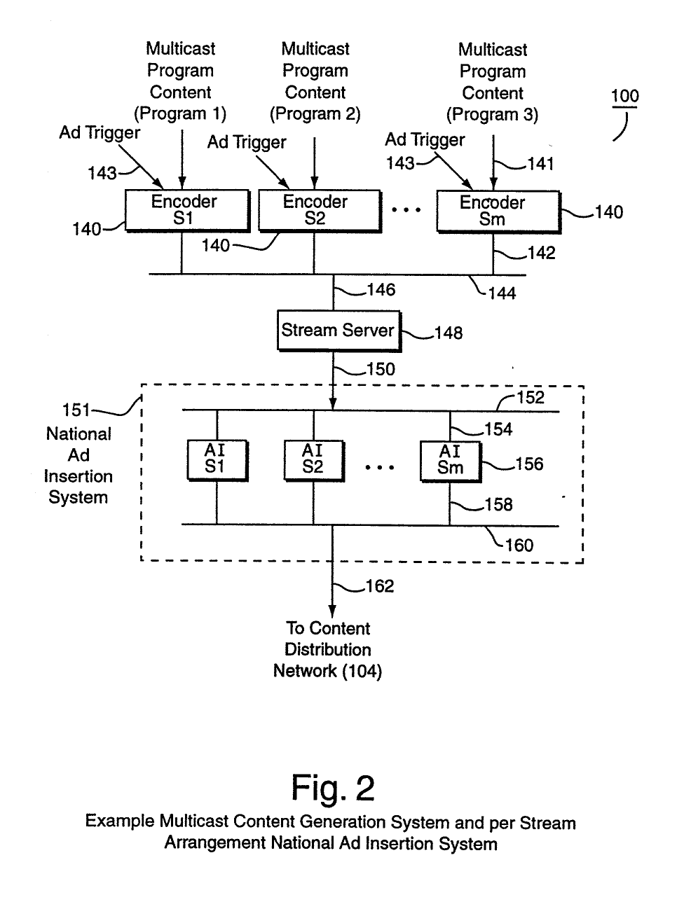

In an example embodiment, such as shown in FIG. 2, a Multicast Content Generation System is connected to or is part of Multicast Content Distribution Network 104, which ultimately delivers the high bandwidth digital multicast content to subscribing recipients that have a PC connected to the Internet. Preferably, each subscriber's PC should be running at least a conventional web browser application and some type of multi-media playback software (such as, for example, Microsoft™ Windows Media Player or Real™ Networks Media Player).

In the example multicast distribution scheme of FIG. 1, insertion of “national” advertisements (i.e., distributed to all recipients) are initiated at multicast program content generation source 100. Regional advertisement insertion (122) and/or regional demographic advertisement insertion (108) is performed after receiving multicast content from a multicast content distribution network (104) but before distribution within a particular regional network (112, 126, 132). Although numerous “injection” points may prove viable for introducing multicast content within any single regional network, in applicants' view optimum performance is generally achieved when the multicast content stream is introduced as physically close as possible to the ultimate users/recipients within a particular regional network.

An example multicast content generation system 100 for implementing national advertisement insertion on a per-content stream basis is illustrated in greater detail in FIG. 2. Multicast content generation system arrangement 100 may be implemented utilizing network/server hardware provided with a commercially available suite of software products such as, for example, Microsoft™ Windows media technology. In this example arrangement, one or more multicast programs (e.g., program #1, program #2, program #n) are provided to one or more content stream encoders 140 which may be coupled via local bus or a LAN (144) to a stream server (148). The multicast programs may be, for example, live or prerecorded audio, video or multimedia content that is provided by one or more conventional source program feeds (not shown). Encoders 140 provide for both digitizing and digital compression of the provided program feeds (141). Digital compressed multicast content (142) is then output to stream server 148 via LAN 144. One or more Encoders may also be arranged to accept an input 143 of specific advertisement triggering command codes (“triggers”) which are embedded into the compressed digital output content stream 142. Such advertisement trigger codes may be used for indicating, for example, the beginning and/or end of an advertisement which is to be embedded in the compressed content stream. Such advertisement trigger codes may also be used to indicate locations within the distributed content stream where advertisements may be subsequently inserted, for example, at a regional distribution level.

Stream server 148, coupled to LAN 144, is responsible for managing the transmission schedule of multicast content streams which are placed in the multicast content distribution network 104. The stream server may consist, for example, of conventional network server hardware that includes a programmable computer and sufficient storage memory to store significant portions of compressed digital program content streams. The stream server is also programmed to provides a user interface for managing the transmission schedule of one or more content streams for distribution throughout content distribution network 104. For example, stream server 148 may be programmed to control the specific times and particular multicast content streams that are provided to content distribution network 104. In other words, stream server 148 may be used to manage and control what is commonly known in the broadcasting industry as a “play list”. In this manner, stream server 148 may be programmed to provide locally saved or stored program content that has been previously digitized (encoded/compressed) and to convert the compressed digital multicast program content into the standard IP multicast format (e.g., IP multicast format as described in RFC 1112 and RFC 2236) before providing it to content distribution network 104. In an example embodiment, applications software such as Microsoft™ Windows media technology suite may be used to provide various streaming media tools such as digital encoding and play list management software.

As shown in the FIG. 2 example, “national” advertisement insertion is performed by National Ad Insertion System 151 which includes one or more advertisement inserter devices (AI S1-AI Sm). A plurality of advertisement insertion devices (AD inserters) 156 may share common LAN arrangement and/or input and output buses 152, 160. AD inserters 156 receive and/or store previously digitized and compressed advertisement content along with advertisement display (play) time information acquired from, for example, a separate advertisement distribution tracking and billing system (not shown) connected to the common bus/LAN 152 arrangement of insertion system 151. This connection may be, for example, implemented using the Internet or some other suitable digital communications link to the tracking and billing system. AD inserters 156 may also function to report to the traffic and billing system the specific times and the Group Address (channel) on which each advertisement was played.

In a preferred example embodiment, each multicast Group Address channel or content “stream”, S1 . . . Sm, that is provided to content distribution network 104 (FIG. 1) has a corresponding AD inserter device 156. Each AD inserter AI S1-AI Sm, may be provided by a separate computer/server or, alternatively, multiple AD inserters may be provided as separate processes run on a single computer server. An example AD insertion arrangement system is disclosed in greater detail in commonly assigned copending application entitled “Method and Apparatus for Injecting IP Multicast Content into an ATM DSL Network”, filed Nov. 16, 2001, and originally filed as U.S. provisional application Ser. Nos. 60/249,290 and 60/254,864, the content of each of which are hereby incorporated by reference into the present application.

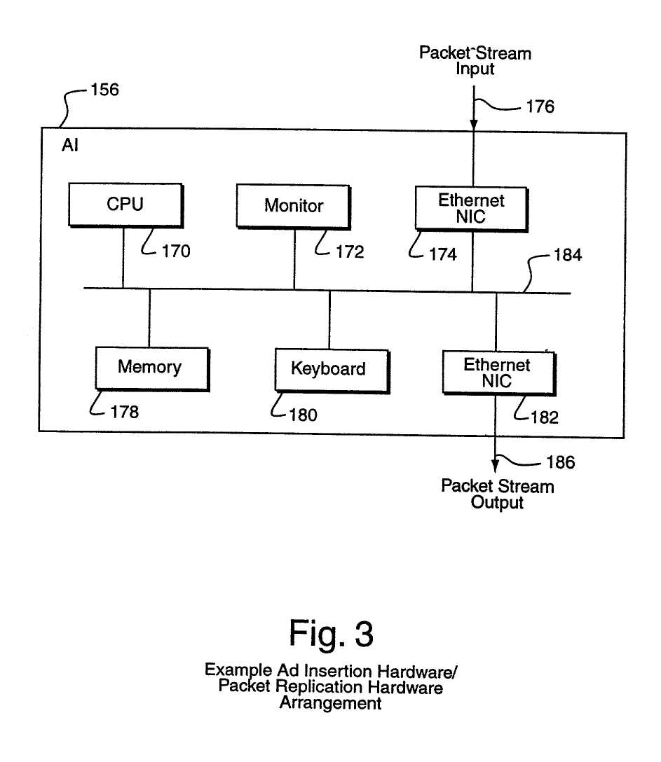

Referring now to FIG. 3, an example hardware arrangement is illustrated which may be used to implement AD inserter 156 of FIG. 2. In this example arrangement, AD inserter 156 consists of a conventional high-performance computer system having a CPU 170, display memory 178 (e.g., RAM and hard disk), monitor device 172, keyboard 180 and a pair of network interface cards (NICs) 174 and 182. In a preferred example embodiment, NIC 174 and 182 are conventional Internet network interface cards capable of operating at 10/100 baseT data rates (for example, the 3-Com™ 3C905 NIC). UDP multicast packets having a specific Group Address and containing compressed multicast content are received at input 176 by NIC 174 and are copied/passed unchanged to output 186 via NIC 182. Advertisements are inserted at an appropriate location in output data stream 186 by deleting received packets from input stream 176 and inserting advertisement packets retrieved from, for example, an advertisement storage file memory 178. Once all the data packets comprising an advertisement are inserted into output stream 186, packets from input stream 176 are once again copied/passed directly to output stream 186.

CPU 170 may utilize, for example, Microsoft Windows™ 2000 operating system and WindSock™ software for controlling advertisement inserter device/system 156 and for handling input and output packet streams 176, 186. In the example embodiment, CPU 170 monitors packet stream input 176 for multicast data packets designated by a specific multicast Group Address. Upon detecting packets having the specific Group Address, advertisement data packet substitution insertion is performed at either predetermined specified times or upon detection of event trigger codes imbedded the received input packet stream.

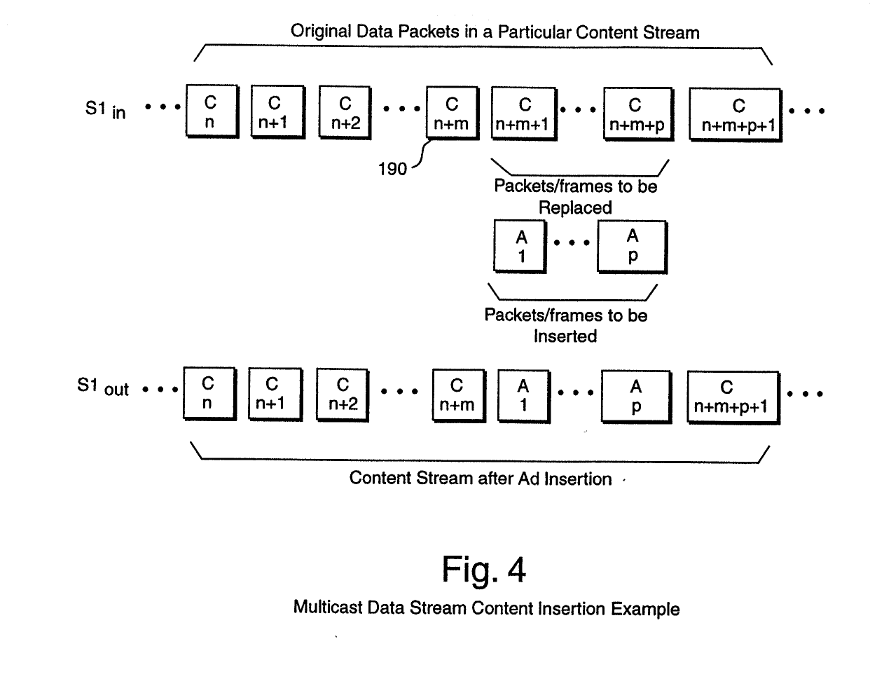

Referring now to FIG. 4, a block diagram is provided as an example to illustrate the manner in which sequence of input data packets, S1ᵢₙ, designated by a specific Group Address and corresponding to in a particular multicast content stream, are replaced with a substitute data packet stream corresponding to the content of an advertisement. In this example, data packets Cₙ₊ₘ₊₁ through Cₙ₊ₘ₊ₚ within content stream S1ᵢₙ are replaced by data packets, A₁ through Aₚ, corresponding to an advertisement. The resulting output stream sequence of data packets is indicated as S1ₒᵤₜ.

Data packet Cₙ₊ₘ (190) may include appropriate advertisement trigger code(s) identifying a certain pre-determined number of subsequent data packets as candidates for packet replacement. Alternatively, such an advertisement trigger code(s) could be used to simply identify the location within the stream where additional packets may be inserted.

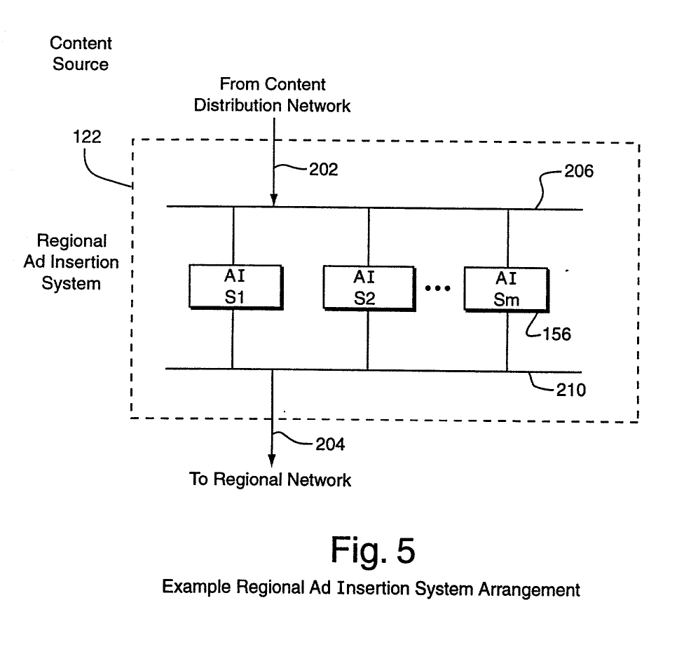

Referring now to FIG. 5, an example architectural arrangement of an advertisement inserter device/system (122) for inserting advertisements at the regional network level is depicted. Essentially, regional advertisement insertion system 122 is structurally identical to the national advertisement insertion system (151) shown in FIG. 2. Although the hardware architecture is basically the same, regional advertisement insertion system 122 is utilized in this example for inserting advertisements directed toward multicast content recipients served by a single regional network (e.g., network 126 in FIG. 1). In this context, regional advertisement insertion system 122 serves only a limited particular geographic region and provides all recipients within that region with the same injected advertisement content regardless of the recipient demographics. Regional advertisements provided at insertion system 122 are inserted into multicast data streams on a per-channel (Group Address) basis, and all users/recipients regional network 126 receive the same identical advertisement content. As illustrated in FIG. 1, each regional network may produce/insert its own local advertisements in this manner.

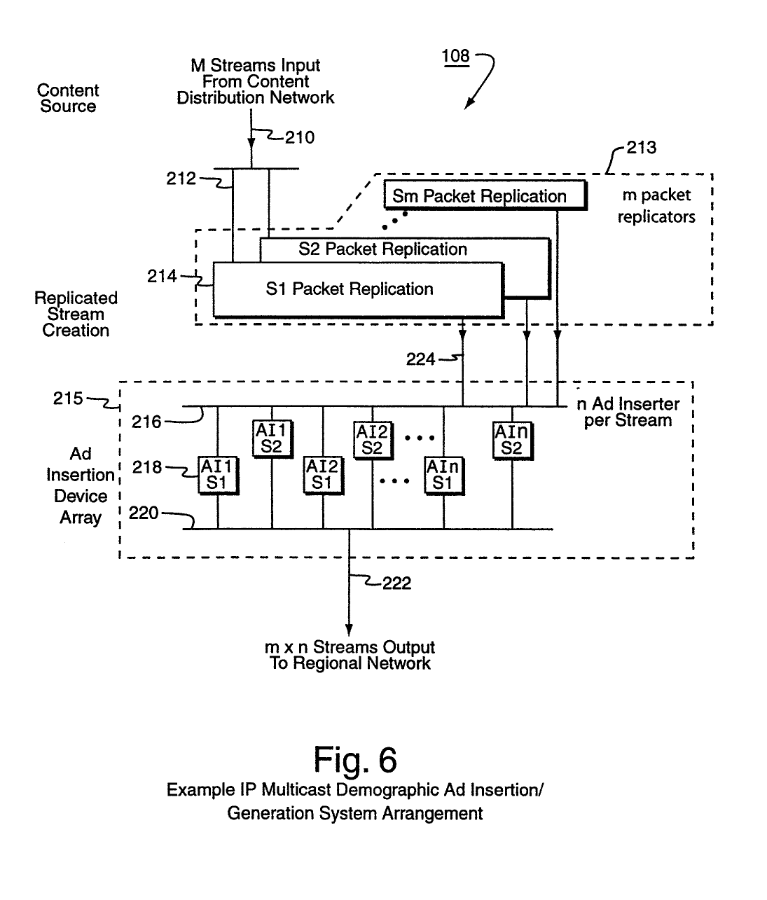

Referring next to FIG. 6 illustrates an example regional demographic advertisement insertion/generation system 108 is illustrated. Regional demographic advertisement insertion system 108 may be used to provide specifically tailored advertisement content to one or more targeted recipients having different selected demographic profiles (e.g., age, sex, etc.). In this example, one or more multicast content streams (e.g., streams S1 through Sm) are provided from the multicast content distribution network via input 210 to a packet replication system (213). Packet replication system 213 may consist of one or more packet replication device (replicator) 214. Each packet replicator 214 within replication system 213 may produce n identical data packets 224 of an original input data packet 212, where n is the number of different possible demographic targets. For example, if a targeted recipient demographic consists of, both two sexes and five distinct age groups (e.g., ages 0-11, 12-18, 19-34, 35-55, 55 and older), then ten distinct demographic categories exist and packet replicator 214 would set to produce ten copies of each original data packet in input stream 212. In this manner, original multicast content stream S1 is reproduced for each of the ten distinct demographic categories. Additional input packet streams, S2 through Sm, may be replicated in the same manner by corresponding packet replicators. Packet replicator 214 may be constructed using known conventional hardware to AD insertion hardware of FIG. 3.

In a preferred example embodiment, all replicated packets are identical to the original source content packets within the source content stream except that during the replication process each packet replicator 214 modifies the Group Address and designation port number corresponding to each stream of replicated copies (associated check sums within each packet may be modified as well). The output of each packet replicator is provided to advertisement insertion device array 215, which may include one or more advertisement insertion devices 218 similar to advertisement insertion device 156 (FIG. 3). In this example, advertisement insertion device array 215 consists of several (at least n) advertisement inserters 218 per replicated multicast content streams S1 through Sm. In this manner, individual advertisements that are customized for a particular demographic (or individual recipient for that matter), may be inserted into a replicated content stream designated for a particular recipient.

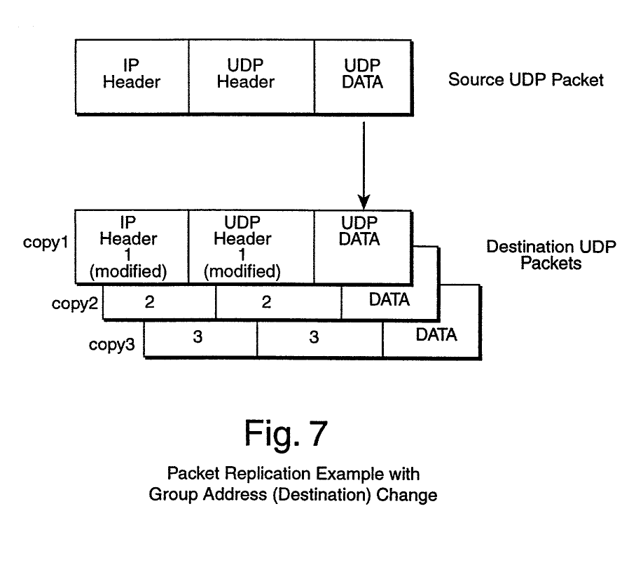

For example, referring to FIGS. 3 and 7, the following operations may be performed on input content stream for each replicated packet for each different demographic group:

copy original packet from input NIC 174 into a buffer (174);

modify the Group Address (destination address) in the IP header (if desired);

compute new IP header check sum (if Group Address was modified);

modify destination port number in IP header (if desired);

compute new UDP header check sum; and

output the modified packet in the buffer to output (182) NIC.

FIG. 7 illustrates a packet replication example wherein each data packet copy generated from a source UDP data packet is modified to contain a unique specific IP header and UDP header. As illustrated by this example, for each duplicated packet, the following operations are performed:

modify destination address in IP header;

modify check sum in IP header;

modify the check sum in the UDP header; and

copy all other bits from source UDP packet to the destination UDP packet.

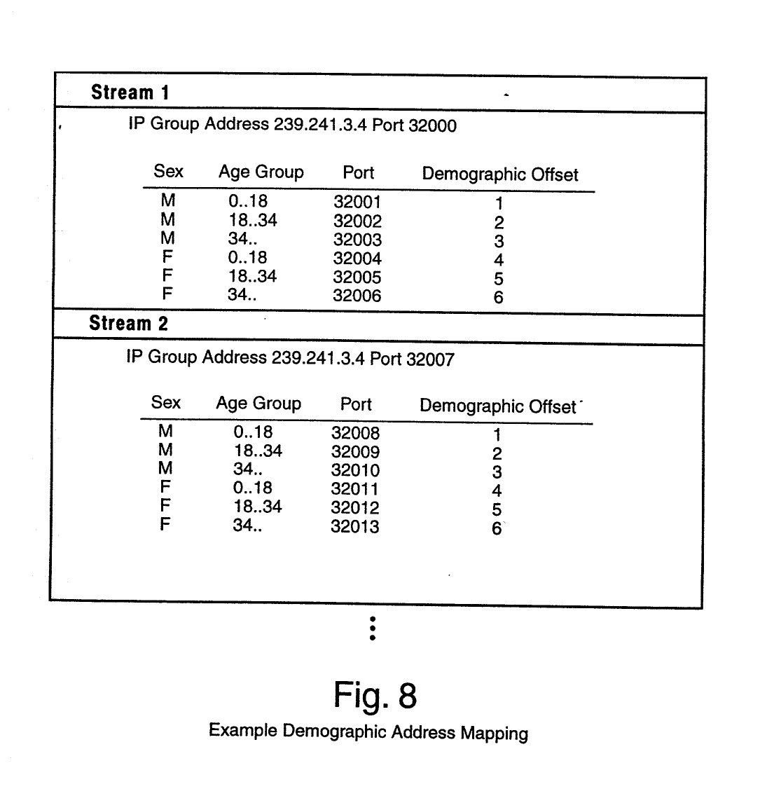

FIG. 8 illustrates an example demographic address mapping scheme. For this example, there are six demographic combinations and one original content stream containing “national” advertisements. The IP address in this example is constant for all streams—only the port number varies with each stream and replicated stream. The “demographic offset” is identical for the same demographic parameters independent of the stream (channel) number.

For a particular multicast data/program content stream containing either national advertisements or specific demographically targeted advertisements, the software multimedia player “plug-in” application operating with a recipients browser program must be directed (pointed) to the specific IP Group Address and port number corresponding to a particular multicast content stream. For this example embodiment, only three parameters are needed:

original Group Address;

original port number; and

port offset based on the recipient's demographics.

Assuming the particular demographically targeted multicast program recipients have a two-way data path via the Internet to a multicast program data base on a server, then the original Group Address and Port number are based on a specific channel number corresponding to a particular multicast program stream, which may be obtained by a request to, for example, a server-side database 101 (FIG. 1) which stores and maintains IP multicast client/recipient information including a mapping from a selected channel/multicast program stream to the Group Address and Port number information for that channel/program stream (e.g., Group Address 239.241.3.4 and port number 32000 corresponding to Stream 1 in FIG. 8). A demographic parameter port offset (e.g., Demographic Offset values 1 through 6 in FIG. 8), which may also be based on the log-in user ID, is also stored in the server-side database (101). Alternatively, if there is only a one-way data path to an intended/targeted recipient via the Internet, then the mapping from channel/stream number to Group Address and port can be provided in a fixed look-up table and the demographic off-set can then be computed and stored in a cookie on the recipient's computer. The particular mapping between channel/stream number and Group Address/Ports is arbitrary with the only caveat being that the multimedia player software application being used must be able to obtain the correct parameters determined by the desired channel and recipients' demographic information.

The example embodiments of the present invention as described herein and above can provide at least the following advantages:

minimizes the bandwidth required to distribute content to a large number of users;

provides the ability to economically deliver nationally-tailored content, such as national advertising, to a large number of users;

provides the ability to economically deliver regionally-tailored content, such as local advertising, to a large numbers of users;

provides the ability to economically deliver demographically targeted regional content to only the specifically targeted regional multicast content recipients;

provides the ability to provide the above features or sub-sets of them to users of the Internet; and

provides the ability to confine the distribution of content via a particular sub-network (e.g., Internet users served through a given local telephone company central office or ISP feeding into such a telephone company) to only the users within the sub-network.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. In a point-to-multipoint IP multicast content distribution network of the type using a satellite communications system to bypass congested portions of a digital communications network and having a satellite downlink receiver being positioned within an ISP, NSP, RBOC or similar digital service network, a system for insertion of national advertisements or other content into one or more nationally distributed IP multicast content streams, comprising:
a program content source providing one or more multicast program content streams for distribution;
a content stream encoder having an input for accepting a multicast program content stream and an input for accepting advertisement triggering commands, said encoder providing digital conversion and/or compression of a multicast program content stream and insertion of advertisement triggering codes into a compressed program content output stream;
a programmable stream server, said server converting a multicast program content stream from one or more content stream encoders into IP multicast format; and
an advertisement insertion device array comprising one or more advertisement insertion devices, wherein an advertisement insertion device of said array replaces packets of data received from said stream server and/or inserts packets of data into a data stream received from said stream server, the inserted and replacement data packets comprising video and/or audio advertisement content for distribution.

2. The multicast content distribution network of claim 1 wherein said stream server includes a programmable user interface for managing a transmission schedule of one or more content streams for distribution throughout the content distribution network.

3. The multicast content distribution network of claim 1 wherein said stream server includes sufficient memory for storing portions of compressed digital multicast program content and is programmed for selectively storing and providing said portions to the content distribution network.

4. The multicast content distribution network of claim 1 wherein said advertisement insertion devices are connected to a separate advertisement distribution tracking and billing system.

5. The multicast content distribution network of claim 1 wherein an advertisement insertion device comprises a computer system including an advertisement storage file memory device for storing data packets of advertisement content.

6. The multicast content distribution network of claim 1 wherein an advertisement insertion device comprises a computer system including at least one network interface device for communicating with the stream server and the content distribution network.

7. The multicast content distribution network of claim 1 wherein an advertisement insertion device comprises a computer system including a display monitor and a keyboard input device for providing a user interface.

8. The multicast content distribution network of claim 1 wherein an advertisement insertion device replaces and/or inserts packets of data into a received data stream in response to one or more advertisement triggering codes embedded in the received data stream.

9. In an IP multicast content distribution network of the type using a dedicated bandwidth portion of a high bandwidth digital communications network infrastructure to bypass congested portions of conventional Internet communications to provide IP multicast content to one or more ISP, NSP, RBOC or similar digital service networks, a system for insertion of regionally directed advertisements and/or other regionally directed program content into an IP multicast content stream to be distributed at a regional distribution level to customers of said ISP, NSP, RBOC or similar digital service networks, comprising:
an advertisement insertion device array located at a point of presence of said ISP, NSP, RBOC or similar digital service networks, said advertisement insertion device comprising one or more advertisement insertion devices, wherein an advertisement insertion device receives packets of IP multicast content data via said content distribution network, and inserts or replaces data packets of received IP multicast content with stored data packets of predetermined advertisement content.

10. The multicast content distribution network of claim 9 wherein said advertisement insertion devices are connected to a separate advertisement distribution tracking and billing system.

11. The multicast content distribution network of claim 9 wherein an advertisement insertion device comprises a computer system including an advertisement storage file memory device for storing data packets of advertisement content.

12. The multicast content distribution network of claim 9 wherein an advertisement insertion device comprises a computer system including at least one network interface device for communicating with the content distribution network.

13. In an IP multicast content distribution network, a regional demographic advertisement insertion system for insertion of demographically directed advertisements or other demographically directed content into a regionally distributed IP multicast content stream provided by an ISP, NSP, RBOC or similar digital service network to its regional customers, comprising:
an IP multicast program content generation source providing one or more multicast program content streams to said content distribution network for distribution;
a plurality of data packet replicators, said replicators receiving one or more of said multicast program content streams via said distribution network and producing one or more replicated portions of said multicast program content streams wherein said replicated portions comprise modified UDP data packets having modified Group Addresses and/or modified destination port numbers corresponding to predetermined targeted recipients; and
an advertisement insertion device array comprising one or more advertisement insertion devices, wherein an advertisement insertion device of said array replaces packets of data received from said plurality of data packet replicators and/or inserts packets of data into a data stream received from said plurality of data packet replicators, the inserted and replacement data packets comprising predetermined video and/or audio advertisement content for distribution to particular targeted recipients.

14. The multicast content distribution network of claim 13 wherein an advertisement insertion device comprises a computer system including an advertisement storage file memory device for storing data packets of advertisement content.

15. The multicast content distribution network of claim 13 wherein said advertisement insertion devices are connected to a separate advertisement distribution tracking and billing system.

16. The multicast content distribution network of claim 13 wherein an advertisement insertion device comprises a computer system including a display monitor and a keyboard input device for providing a user interface.

17. The multicast content distribution network of claim 13 wherein a packet replicator device comprises a computer system including a display monitor and a keyboard input device for providing a user interface.

18. In an IP multicast content distribution network of the type using a dedicated bandwidth portion of a high bandwidth digital communications network infrastructure to bypass congested portions of conventional Internet communications to provide IP multicast content to an ISP, NSP, RBOC or similar digital service network, a system for insertion of national and/or regional advertisements or other content into a distributed IP multicast content stream, comprising:
an IP multicast program content generation source providing one or more multicast program content streams;
a content stream encoder having an input for accepting a multicast program content stream and an input for accepting advertisement triggering commands, said encoder providing digital conversion and/or compression of a multicast program content stream and insertion of advertisement triggering codes into a compressed program content output stream;
a programmable stream server, said server converting a multicast program content stream from one or more content stream encoders into IP multicast format;
an advertisement insertion device array comprising one or more advertisement insertion devices, wherein an advertisement insertion device of said array replaces packets of data received from said stream server and/or inserts packets of data into a data stream received from said stream server prior to providing said data stream to said content distribution network, the inserted and replacement data packets comprising video and/or audio advertisement content for national distribution; and
an advertisement insertion device array located at a point of presence of said ISP, NSP, RBOC or similar digital service network, said advertisement insertion device comprising one or more advertisement insertion devices, wherein an advertisement insertion device receives packets of IP multicast content data via said content distribution network, and inserts or replaces data packets of received IP multicast content with data packets of predetermined advertisement content.

19. The multicast content distribution network of claim 18 further comprising one or more data packet replicators, said replicators receiving one or more of said multicast program content streams via said distribution network and producing one or more replicated portions of said multicast program content streams wherein replicated packets of said replicated portions have modified IP multicast Group Addresses and/or modified destination port numbers corresponding to predetermined targeted IP multicast program content recipients.

20. The multicast content distribution network of claim 19 wherein at least one packet replicator device comprises a computer system including a display monitor and a keyboard input device for providing a user interface.

21. The multicast content distribution network of claim 18 wherein an advertisement insertion device comprises a computer system including an advertisement storage file memory device for storing data packets of advertisement content.

22. The multicast content distribution network of claim 18 wherein said advertisement insertion devices are connected to a separate advertisement distribution tracking and billing system.

23. In an IP multicast content distribution network arrangement that provides one or more IP multicast program content streams of predetermined streaming digital content to subscribing Internet users, said distribution network comprising an arrangement for inserting advertisements or other streaming digital content into a regionally distributed IP multicast content stream provided by an ISP, NSP, RBOC or similar digital service network to its regional customers, a method for inserting advertisements and/or other streaming digital content into predetermined IP multicast program content streams on a per stream basis, comprising the steps of:
a) producing multiple streams of IP multicast program content;
b) embedding one or more trigger codes into predetermined IP multicast program content streams; and
c) distributing said one or more or said streams to a content insertion device located at a point of presence of an ISP, NSP, RBOC or similar regional digital service network provider, wherein said device inserts predetermined advertisements or other digital program content into a particular IP multicast program content stream in response to said trigger codes.

24. The method claim 23 wherein predetermined advertisements or other digital program content to be used for insertion into a particular IP multicast program content stream is maintained on a memory storage device maintained by said content insertion device.

25. The method claim 23 further comprising the steps of:
replicating UDP data packets comprising one or more portions of an IP multicast program content stream received at a point of presence of said ISP, NSP, RBOC or similar regional digital service network provider; and
modifying an IP multicast Group Addresses and/or destination port numbers within said packets to correspond to IP multicast Group Addresses and/or destination port numbers of predetermined targeted IP multicast program content recipients.

26. In an IP multicast content distribution network that provides one or more predetermined IP multicast program content streams of streaming digital content to an ISP, NSP, RBOC or similar regional digital service network for distribution to subscribing Internet users, said distribution network including equipment located at a point of presence of said ISP, NSP, RBOC or similar regional digital service network for inserting streaming digital content into an IP multicast content stream provided by said ISP, NSP, RBOC or similar regional digital service network to its regional customers, a method for inserting demographically targeted advertisements and/or other demographically targeted streaming digital content into IP multicast program content streams on a per stream basis for delivery to predetermined targeted IP multicast program content recipients, comprising the steps of:
a) receiving one or more of said multicast program content streams at said ISP, NSP, RBOC or similar digital service network and replicating received IP multicast data packets to produce one or more replicated portions of said multicast program content streams;
b) modifying IP header and UDP header information per data packet within predetermined replicated portions of said multicast program content streams such that at least some replicated portions comprise UDP data packets having modified Group Addresses and/or modified destination port numbers corresponding to predetermined targeted recipients;
c) inserting data packets comprising a predetermined advertisement or other demographically targeted streaming digital content into one or more of said predetermined replicated portions of said multicast program content streams using corresponding modified IP header and UDP header information per data packet; and
d) providing said replicated portions to particular targeted recipients corresponding to said modified Group Addresses and/or modified destination port numbers.

27. In an IP multicast content distribution network arrangement that provides one or more IP multicast program content streams of streaming digital content to subscribing Internet users, a method for inserting national, regional, and/or demographically targeted information content into one or more multicast streams, comprising the steps of:
a) producing multiple streams of IP multicast program content;
b) replicating IP multicast data packets;
c) modifying IP header and UDP header information per data packet in predetermined replicated data packets to be provided to a particular predetermined recipient;
d) inserting data packets comprising advertisement or other program content into a predetermined IP multicast data stream, said inserted data packets having correspondingly modified IP header and UDP header information per data packet; and
e) providing said predetermined IP multicast data stream to Internet users corresponding to modified IP header and UDP header information in each data packet.

28. In an IP multicast content distribution network having a regional demographic advertisement insertion system for insertion of demographically directed advertisements or other demographically directed content into a regionally distributed IP multicast content stream provided by an ISP, NSP, RBOC or similar digital service network to its regional customers, a method for mapping multicast program content streams to particular demographically targeted recipients, comprising the steps of:
a) associating one or more IP multicast content stream recipients into one or more demographic categories, each category associated with one or more demographic parameters, said parameters corresponding to one or more predetermined characteristics and/or personal preferences associated with a particular recipient;
b) assigning a particular IP port number and a particular associated demographic offset value to each of said one or more demographic categories, wherein each assigned port number corresponds to a different particular IP multicast content data stream;
c) maintaining a database for storing said demographic categories, associated IP multicast content stream recipients, assigned IP port numbers and associated demographic offset values; and
d) using a particular demographic offset value as an index to a particular port number when providing an IP multicast data stream to a recipient, said particular demographic offset value based on a recipient's demographic characteristics maintained in said database.

29. The method claim 28 wherein said database is a server-side database maintained by said ISP, NSP, RBOC or similar digital service network.

30. The method claim 28 wherein at least a portion of said database information is stored in a cookie on a recipient's computer system.
